(19) United States
(12) Patent Application Publication
(10) Pub. No.: US 2013/0314424 A1
(43) Pub. Date: Nov. 28, 2013

(54) Display System for Electronic Device and Display Module Thereof

(71) Applicant: AsusTek Computer Inc., Taipei (TW)

(72) Inventors: Cheng-Yao HUANG, Taipei (TW); Chia-Hui HAN, Taipei (TW); Huei-Ping TZENG, Taipei (TW); Wen-Chien YEN, Taipei (TW); Calvin Wing-Hang KU, Taipei (TW); Wei-Wen LUO, Taipei (TW); Hsien-Kuang CHIU, Taipei (TW)

(21) Appl. No.: 13/895,182

(22) Filed: May 15, 2013

Related U.S. Application Data
(60) Provisional application No. 61/650,125, filed on May 22, 2012.

(30) Foreign Application Priority Data
Mar. 27, 2013 (CN) 201310101972.5

(51) Int. Cl. G06F 3/14

(52) U.S. Cl. CPC G06F 3/1431
USPC 345/501

(57) ABSTRACT

A display module of an electronic device is for showing an operation interface of a first screen on a second screen of the electronic device, and the first screen is disposed on an opposite side of the second screen. The display module includes a graphics processing unit and a screen control unit. The graphics processing unit is coupled to a processing unit of the electronic device, the graphics processing unit receives display information from the processing unit, and the display information has a first pixel data, and the graphics processing unit processes the first pixel data to generate second pixel data. The screen control unit outputs the first pixel data to the second screen and a second display frame is displayed, and the screen control unit receives the second pixel data and outputs the second pixel data to the operation interface.

### CROSS-REFERENCE TO RELATED APPLICATION

This application claims the priority benefit of U.S. provisional application Ser. No. 61/650,125, filed on May 22, 2012, and Patent Application No. 201310101972.5 filed in People's Republic of China on Mar. 27, 2013. The entirety of the above-mentioned patent applications are hereby incorporated via reference herein and made a part of specification.

### BACKGROUND OF THE INVENTION

1. Field of the Invention

This invention relates to a display system and, more particularly, to a display system for an electronic device.

2. Description of the Related Art

An electronic device such as a notebook computer usually displays a report or a multimedia file on an extended screen projected by a projector. Meanwhile, the user can operate the notebook computer to execute other programs. For example, the user can open or move other files or windows and execute other operation interfaces to have a multiplex processing effect, and it would not affect or change the content of the report. Consequently, to allow multiple users to watch the displayed content or other multimedia files, a projector should be used along with a notebook, which is rather inconvenient.

Additionally, if the user wants to look at the report to explain, the user only can watch the screen projected by the projector, similar the listener. For example, when the user controls the multimedia file such as fast forwarding, rewinding the video file or controlling the subtitle at the operation terminal such as an input device, the user needs to confirm whether the displayed content is correct at the projected screen but not from the operation terminal. Thus, it is inconvenient for the user to control the report and the multi-media file.

### BRIEF SUMMARY OF THE INVENTION

A display system and a display module are provided. The report and the multi-media are played meanwhile on an electronic device without the projector. A first screen of the operational terminal of the electronic device can display the frame displayed on a second screen, and there is no delay in showing the frame and it does not affect the performance of the central processor.

The display system includes a first screen, a second screen, a processing unit and a display module. The first screen displays a first display frame, and the first display frame displays an operation interface. A second screen is disposed at an opposite side of the first screen, and the second screen displays a second display frame. The processing unit is coupled to the first screen and the second screen, the processing unit executes the operation interface and displayed data, and the display data includes a first pixel data. The display module includes a graphic processing unit and a screen control unit. The graphic processing unit is coupled to the processing unit, and the graphic processing unit receives the display data from the processing unit. Then, the graphics processing unit processes the first pixel data to get second pixel data. The screen control unit is coupled to the processing unit, the graphic processing unit, the first screen and the second screen. The screen control unit outputs the first pixel data to the second screen to generate the second display frame. The screen control unit receives the second pixel data and outputs the second pixel data to the operation interface and the second screen, and the second display frame is generated. The screen control unit receives the second pixel data and outputs it to the operation interface.

The display module of an electronic device is used to display the operation interface of the first screen on the second screen, and the second screen is disposed at the opposite side of the first screen. The display module includes the graphic processing unit and the screen control unit. The graphic processing unit is coupled to the processing unit. The graphic processing unit receives the display data from the processing unit and process the display data to get a first pixel data. The graphic processing unit processes the first pixel data to get a second pixel data. The screen control unit is coupled to the processing unit, the graphic processing unit, the first screen and the second screen. The screen control unit outputs the first pixel data to the second screen and the second display frame is generated, and the screen control unit receives the second pixel data and outputs the second data to the operation interface.

Based on above, the display system and the display module can process the first pixel data to get the second pixel data via the graphic processing unit, and the second display frame is generated and outputted to the operation interface. The operation interface can display the change of the second display frame in real time due to the processing of the graphic processing unit. In other words, there is no delay in the executing of the real time display control command, and it does not affect the performance of the processing unit.

Furthermore, the user does not need to wait for the operating time of the processing module, and the user can know that whether the command is inputted. Thus, when the interactive program is a video playing program, the user can immediately know that whether the point in time of fast forwarding and rewinding is correct, the operation doesn't need to repeat, and it saves time.

### BRIEF DESCRIPTION OF THE DRAWINGS

FIG. 1 is a block diagram showing a display system in an embodiment;

FIG. 2 is a schematic diagram showing that the display system in FIG. 1 is applied in an electronic device;

FIG. 3A and FIG. 3B are schematic diagrams showing that the operation of a first screen and a second screen in FIG. 1;

FIG. 4 is a schematic diagram showing the first screen and the second screen in FIG. 3B in another embodiment;

FIG. 5 is a schematic diagram showing that the first screen, the second screen, the processing unit and the display module in FIG. 1; and

FIG. 6 is a schematic diagram showing a zoomed dimension of the second display frame and the operation interface.

### DETAILED DESCRIPTION OF THE EMBODIMENTS

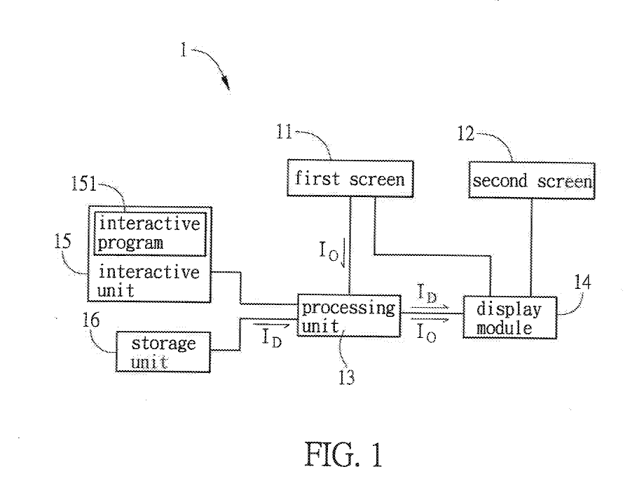

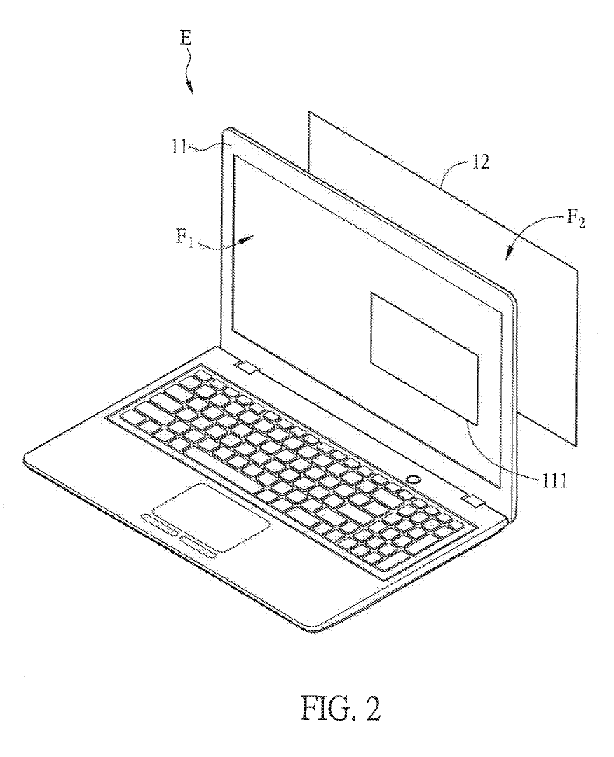

FIG. 1 is a block diagram showing a display system in an embodiment, FIG. 2 is a schematic diagram showing that the display system in FIG. 1 is applied in an electronic device. Referring to FIG. 1 and FIG. 2, the display system 1 of the electronic device E includes a first screen 11, a second screen 12, a processing unit 13 and a display module 14. Referring to FIG. 2, the first screen 11 includes a first display frame F1 displaying an operating system. The second screen 12 is disposed at an opposite side of the first screen 11. The second screen 12 has a screen extending function, and it can display a report and play other multimedia files. That is, the second screen 12 displays a second display frame F2. The second screen 12 is separated from the first screen 11 in FIG. 2 for clearly shown the two screens. However, the second screen 12 is connected with the first screen 11 practically. Thus, it can display the report. and play the multimedia file simultaneously in the electronic device without a projector, and it is more convenient for the user.

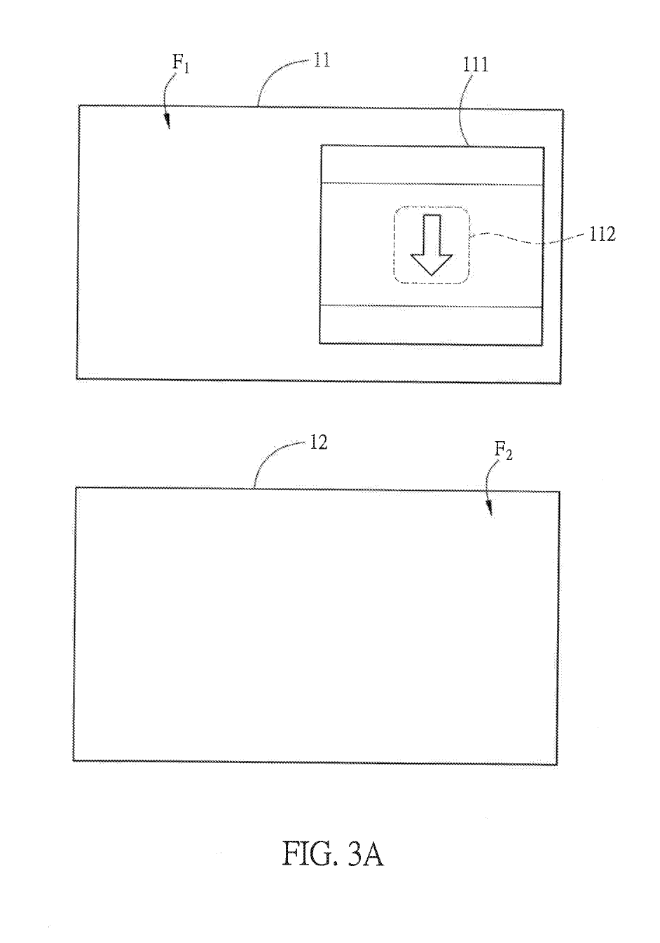

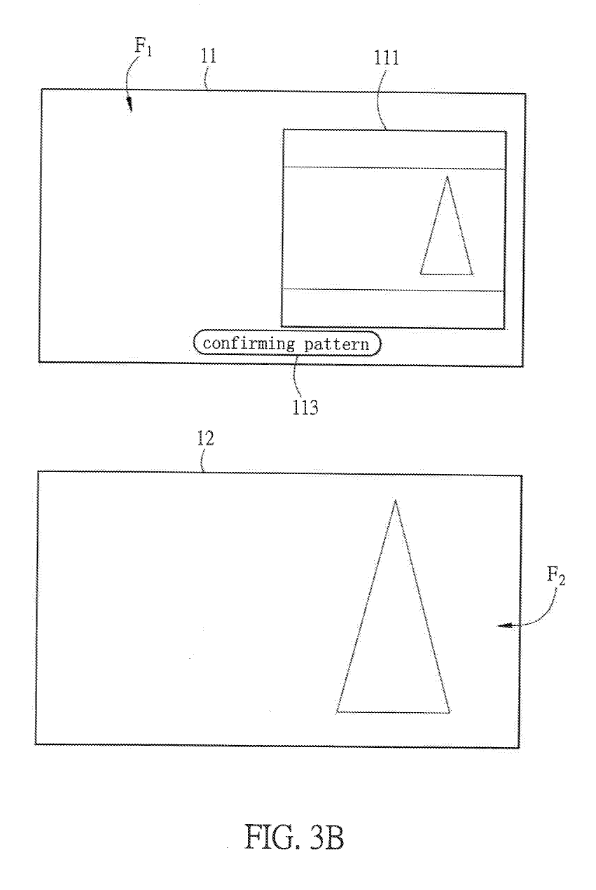

FIG. 3A and FIG. 3B are schematic diagrams showing the operation of the first screen and the second screen in FIG. 1. Referring to FIG. 1, FIG. 3A and FIG. 3B, the first screen 11 displays an operation interface 111, and the processing unit 13 can execute the operation interface 111. The display system 1 further includes an interactive unit 15, and the interactive unit 15 includes at least an interactive program 151. The interactive unit 15 is coupled to the processing unit 13, and the processing unit 13 is electronically connected to the first screen 11. The interactive program 151 is executed via the processing unit 13 (that is, enabling the interactive program 151), and the operation dace 111 (shown in FIG. 3A and FIG. 3B) of the interactive program 151 is displayed at the first display frame F1 of the first screen 11. The interactive program 151 may include an image playing program, a video playing program, a text inputting program or a drawing program, which is not limited herein.

The processing unit 13 is electronically connected to the second screen 12, and the processing unit 13 can execute the operation interface 111 and a display data ID. For example, the processing unit 13 can detect and execute an operation instruction IO at the operation interface 111, and the operation instruction IO includes displaying a second display frame F2 on the second screen 12. The operation interface 111 includes an input field 112 for inputting the operation instruction IO. When the interactive program 151 is an image playing program, the user can input the storage location of the image file at the input field 112, and the user also can drag the file pattern corresponding to the image file to the input field 112 via the cursor. After completing the inputting, as shown in FIG. 3B, the operation interface 111 displays a confirming pattern 113. The processing unit 13 can detect the operation of clicking the confirming pattern 113 and make the second screen 12 display the image corresponding to the image file. In this embodiment, the image file is the display data ID, and the second screen 12 can display the image frame (that is the second display frame F2) corresponding to the display file ID. In FIG. 3A, the operation instruction IO is not inputted, and thus the second screen 12 does not display any image.

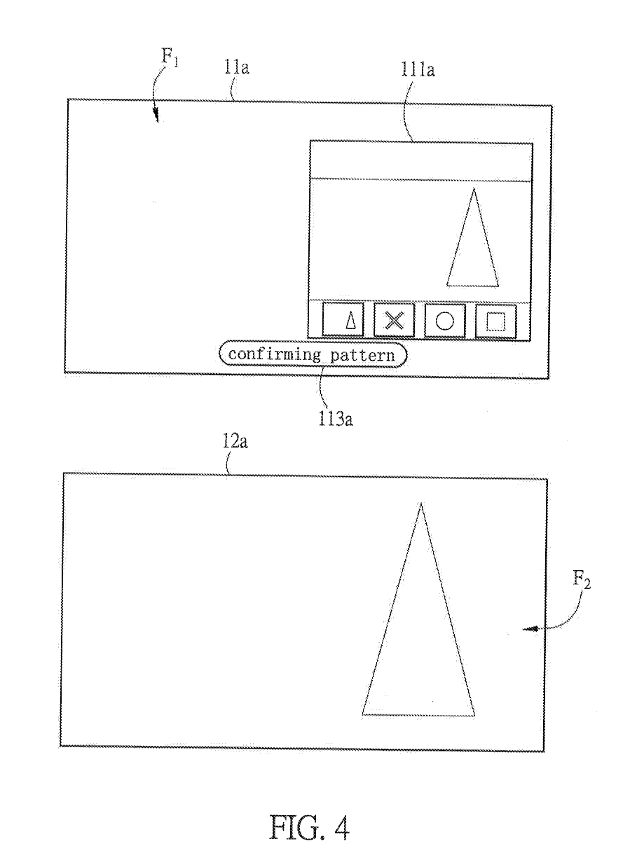

Moreover, FIG. 4 is a schematic diagram showing the first screen and the second screen in FIG. 3B in another embodiment. Referring to FIG. 1 and FIG. 4, the user can input the storage locations of a plurality of image files in the input field 112a at one time, and the user also can drag the file patterns of the image files into the input field 112a via the cursor. After completing the input, the user can click one of the file patterns of the image files, and then click the confirming pattern 113a. The processing unit 13 can detect the motion of clicking the confirming pattern 113a and make the second screen 12a display the image of the image file. The image files also can be played automatically in sequence, which is not limited herein.

The above detecting and executing motion is defined as the operation instruction IO. When the interactive program 151 is a video playing program, a text inputting program or a drawing program, the operation instruction IO includes the motions of clicking the confirming pattern 113 and displaying videos, text or the drawing image, respectively. The real-time image, the real-time video, the real-time text or the real-time drawing image displayed on the second screen 12 is called the second display frame F2. Referring to FIG. 1, the display system further includes a storage unit 16 storing the display information or the data information of the image file, the video file or the text file. The display information is a collection of the display information ID, in other words, the display information ID further includes the video information or the text information. When the processing unit 13 receives the operation instruction IO, the display information ID is transmitted to the processing unit 13. Thus, the processing unit 13 includes a display information ID corresponding to the second display frame F2. Additionally, the second display frame F2 is a real-time image, and it changes along with different time points. Thus, the display information ID changes along with different time points.

After the processing unit 13 receives the display information ID, it can further transmit the display information ID to the display module 14. After the display module 14 processes the display information ID, the second screen 12 displays the second display frame F2 corresponding to the display information ID.

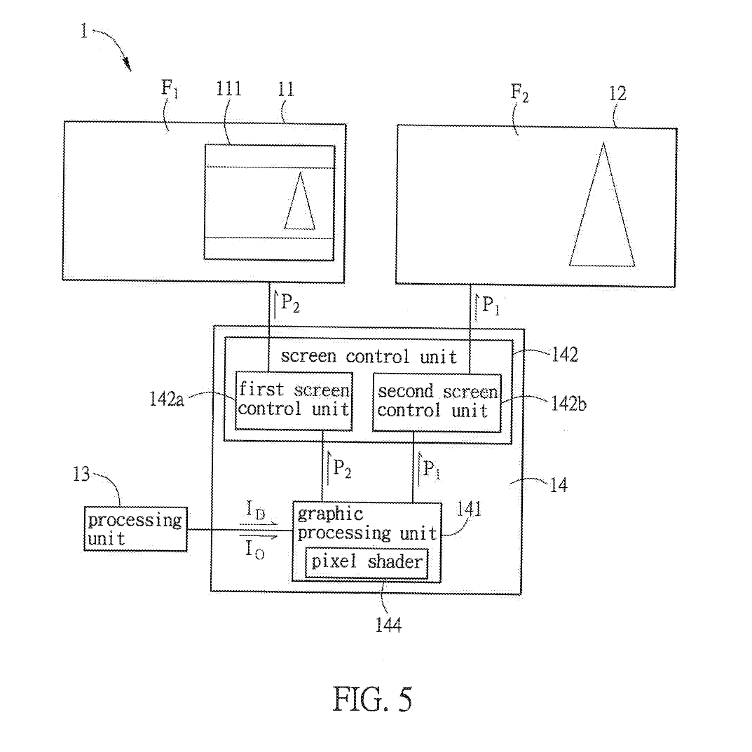

FIG. 5 is a schematic diagram showing the first screen, the second screen, the processing unit and the display module in FIG. 1. Referring to FIG. 3B and FIG. 5, the display module 14 includes a graphic processing unit (GPU) 141 and a screen control unit 142. The screen control unit 142 may further include a first screen control unit 142a and a second screen control unit 142b. The graphic processing unit 141 is coupled to the processing unit 13, and the graphic processing unit 141 receives the display information ID from the processing unit 13. The display information ID includes a first pixel data. The screen control unit 142 is coupled to the processing unit 13, the graphic processing unit 141, the first screen 11 and the second screen 12. After the graphic processing unit 141 receives the display information ID, it converts the display information ID to the corresponding first pixel data P1 and transmits the corresponding first pixel data P1 to the screen control unit 142, the screen control unit 142 outputs the first pixel data P1 to the second screen 12, and the second display frame F2 is displayed. The second screen control unit 142b receives the first pixel data P1 and makes the first pixel data P1 generate the second display frame F2, The second screen control unit 142b is coupled to the second screen 12, and the second display frame F2 is outputted to the second screen 12.

To watch the second display frame F2 of the second screen 12 at the first screen 11 meanwhile, the graphic processing unit 141 processes and coverts the first pixel data PI to get the second pixel data P2, the screen control unit 142 receives the second pixel data P2 and outputs it to the operation interface 111. Thus, the operation interface 111 includes the second display frame F2 of a zoomed dimension. The first screen control unit 142a is coupled to the graphic processing unit 141 and the first screen 11. The first screen control unit 142a can receive the second pixel data P2 from the graphic processing unit 141 and generate a frame correspondingly. The first screen control unit 142a outputs the frame to the operation interface 111 to display.

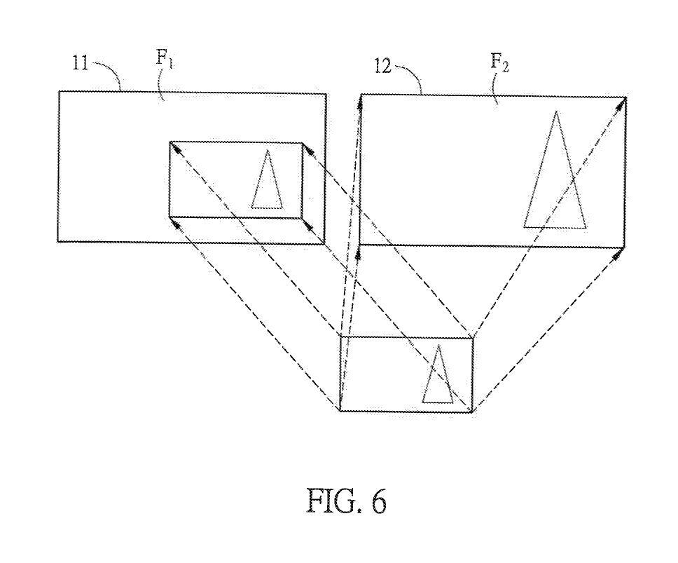

FIG. 6 is a schematic diagram showing a zoomed dimension of the second display frame and the operation interface. The operation interface 111 is the zoomed dimension of the second display frame F2. In this embodiment, the operation interface 111 is a zoomed-out dimension of the second display frame F2. In other embodiments, it can be the same dimension or the zoomed-in dimension, which is not limited herein. Referring to FIG. 5, the graphic processing unit 141 has a down-sampling operation or a re-sampling operation on the first pixel data P1 to get the second pixel data P2. The operation method operated by the graphic processing unit 141 such as converting the display information ID to the first pixel data P1, the down-sampling operation and the re-sampling operation can be any operation method which can be achieved by persons having ordinary skill in the art. For example, the operation method may be a vertex processing, a clipping, a primitive assembly, a triangle setup, a rasterization, an occlusion culling, a parameter interpolation or a pixel shader method. In this embodiment, a bi-linear interpolation is used to do the down-sampling operation and the re-sampling operation. The graphic processing unit 141 further includes a pixel shader 144 to execute the bi-linear interpolation and obtain the second pixel data P2. The graphic processing unit 141 further transmits the second pixel data P2 to the first screen control unit 142a to display the initial address of the memory.

The user can control the second display frame F2 by operating the operation interface 111 directly. For example, zooming in or out the second display frame F2, the motion of enlarging and shrinking the frame at the operation interface can be detected by the processing unit 13 and regarded as the operation instruction IO. At the time, the processing unit 13 also can transmit the operation instruction IO to the graphic processing unit 141 to make the graphic processing unit 141 zoom in or zoom out the second display frame F2 by the above operational method. The first pixel data P1 corresponding to the real-time image of the zoomed second display frame F2 is processed by the graphic processing unit 141 to get the second pixel data P2, and then the first screen control unit 142a receives the second pixel data P2, generates and outputs a corresponding frame to the operation interface 111. The detail of the components can refer to above descriptions, which is omitted herein.

Conventionally, according to a method of displaying a second display frame at the operation interface 111, the second display frame F2 is captured continually and transmitted to the first screen 11 to be displayed on the operation interface 111. In the method, the processing unit 13 needs to process vast captured projection frames, and thus the first screen 11 may have delayed in displaying the changes of the second display frame F2. Consequently, the first screen 11 cannot synchronize with the second screen 12 to display the frames, and it greatly affects the processing efficiency of the processing unit. By contrast, in the embodiment, the graphic processing unit 141 processes the first pixel data P1 and gets the second pixel data P2 directly, the first screen control unit 142a generates a zoomed frame corresponding to the second display frame F2, and displays the zoomed frame at an operation interface 111 of the first screen 11. By the direct operation of the graphic processing unit 141, the change of the second display frame F2 can be displayed synchronously. In other words, it has no delay in executing the real-time display operation command IO instantaneously, and it would not affect the processing efficiency of the processing unit 13.

Moreover, the effect of displaying the frames with no delay is more obvious when the interactive program 151. is a video playing program, the user can execute the operation instruction IO of fast forwarding or rewinding on the zoomed frame which is displayed on the operation interface 111. The processing unit 13 executes the operation instruction IO, the display information ID at a specific time point is transmitted to the graphic processing unit 141 and processed by the graphic processing unit 141, and the second screen control unit 142b controls the second. screen 12 to display the second display frame F2. Simultaneously, the graphic processing unit 141 processes to get the second pixel data P2, and the first screen control unit 142a displays the change of the second display frame F2 at the operation interface 111 without any delay. The user does not need to wait for the processing time of the processing unit 13, and the user also can know whether the selected time point in fast forwarding or rewinding is correct immediately, which can save the operating time.

Additionally, the second screen 12 also may be a touch screen, the operation instruction IO can be inputted by the second screen 12, and it is detected and executed by the processing unit 13. Then, after the processing of the display module 14, the frame is displayed on the first screen 11 and the second screen 12. The operation mode of the components can refer to above descriptions, which is omitted herein.

Furthermore, a display module of the electronic device is provided to display the operation interface of the first screen at the second screen of the electronic device, and the second screen is disposed at the opposite side of the first screen. The display module includes a graphic processing unit and a screen control unit. The graphic processing unit is coupled to a processing unit of the electronic device, the graphic processing unit receives the display information from the processing unit, the display information includes the first pixel data, and the first pixel data is processed to get the second pixel data. The screen control unit is coupled to the processing unit, the graphic processing unit, the first screen and the second screen. The screen control unit outputs the first pixel data to the second screen to generate the second display frame, and the screen control unit receives the d pixel data and outputs it to the operation interface. The components and the operation mode are same to that of the display module of the display system, and the details can refer to above description, which is omitted herein.

In sum, according to the display system and the display module in embodiments, a GPU can process the first pixel data to get the second pixel data directly, and a second display frame is directly generated and outputted to an operation interface. The operation interface can display the change of the second display frame instantaneously due to the direct operation of the GPU. In other words, the execution situation of the command is displayed instantaneously without delay, and it would not affect the processing efficiency of the processing unit.

Moreover, the user does not need the time to wait for the processing of the processing unit, and he or she can synchronously know whether there is an input command. When the interactive program 151 is the video playing program, the user can know whether the selected time point in fast forwarding or rewinding is correct instantaneously, it does not need to operate repeatedly and save time.

Although the disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A display system of an electronic device, comprising:
a first screen including a first display frame, wherein the first display frame displays an operation interface;
a second screen disposed at an opposite side of the first screen, wherein the second screen displays a second display frame;
a processing unit electronically connected to the first screen and the second screen, wherein the processing unit executes the operation interface and a display information, and the display information includes a first pixel data; and
a display module, including:
a graphic processing unit (GPU) coupled to the processing unit, wherein the graphic processing unit receives the display information from the processing unit, processes the first pixel data to get a second pixel data; and
a screen control unit coupled to the processing unit, the graphic processing unit, the first screen and the second screen, wherein the screen control unit outputs the first pixel data to the second screen to generate a second display frame, and the screen control unit receives the second pixel data and outputs the second pixel data to the operation interface.

2. The display system according to claim 1, wherein the graphic processing unit has a down-sampling operation on the first pixel data to get the second pixel data.

3. The display system according to claim 1, wherein the operation interface has a zoomed dimension of the second display frame.

4. The display system according to claim 1, wherein the display system further includes:
an interactive unit including an interactive program, the interactive unit is coupled to the processing unit, the processing unit executes the interactive program, and the first screen displays the operation interface.

5. The display system according to claim 4, wherein the interactive program includes an image playing program, a video playing program, a text inputting program and a drawing program.

6. The display system according to claim 1, wherein the operation interface has an input field for inputting an operation instruction.

7. The display system according to claim 1, wherein the display system further includes:
a storage unit storing the display information.

8. The display system according to claim 7, wherein the display information includes video information or text information.

9. The display system according to claim 1, wherein the screen control unit includes:
a first screen control unit outputting the first pixel data to the second screen to generate the second display frame;
a second screen control unit receiving the second pixel data and outputting the second pixel data to the operation interface.

10. A display module of an electronic device, used to display an operation interface of a first screen at the second screen of the electronic device, wherein the second screen is disposed at an opposite side of the first screen, and the display module comprising:
a graphic processing unit coupled to a processing unit of the electronic device, wherein the graphic processing unit receives a display information from the processing unit, the display information includes first pixel data, and the first pixel data is processed to generate second pixel data;
a screen control unit coupled to the processing unit, the graphic processing unit, the first screen and the second screen, wherein the screen control unit outputs the first pixel data to the second screen to generate the second display frame, and the screen control unit receives the second pixel data and outputs the second pixel data to the operation interface.

11. The display module according to claim 10, wherein the graphic processing unit has a down-sampling operation and a re-sampling operation on the first pixel data to generate the second pixel data.

12. The display system according to claim 10, wherein the operation interface includes a zoomed dimension of the second display frame.

13. The display module according to claim 10, wherein the operation interface has an input field for inputting an operation instruction.

14. The display module according claim 10, wherein the screen control unit includes:
a first screen control unit outputting the first pixel data to the second screen to generate the second display frame; and
a second screen control unit, wherein the second screen control unit receives the second pixel data and outputs the second pixel data to the operation interface.
